(19) United States
(12) Patent Application Publication
(10) Pub. No.: US 2021/0063735 A1
(43) Pub. Date: Mar. 4, 2021

(54) METHOD AND DEVICE FOR CONTROLLING IMAGE DISPLAY IN A VR SYSTEM, AND VR HEAD MOUNTED DEVICE

(71) Applicant: GOERTEK INC., Weifang City, Shandong Province (CN)

(72) Inventors: Lei CAI, Weifang City (CN); Tianrong DAI, Weifang City (CN)

(21) Appl. No.: 16/631,136

(22) PCT Filed: Aug. 1, 2019
(86) PCT No.: PCT/CN2019/098833

§ 371 Date: Jan. 14, 2020

(30) Foreign Application Priority Data
Dec. 29, 2018 (CN) 201811646123.7

(51) Int. Cl. G02B 27/01; G02B 27/00; G06T 3/00; G06T 15/00

(52) U.S. Cl. CPC G02B 27/0101; G02B 27/0093; G06T 3/0093; G06T 2207/20; G02B 2027/014; G02B 2027/0138; G06T 15/00

(57) ABSTRACT

A method and device for controlling image display in a VR system, and a VR head mounted device. The method comprises: monitoring a synchronization signal of an image frame in a VR system and acquiring an original 2D image; sampling sensor data at a preset time point before a next synchronization signal arrives to obtain latest pose information of a tracked object; converting the original 2D image into a corresponding 3D image, and calculating a motion vector corresponding to each pixel point of the 3D image according to the latest pose information and pose information corresponding to the 3D image; performing position transformation on pixel points of the original 2D image based on the motion vector, and filling at pixel points of a vacant area appearing after the position transformation to obtain a target frame; and triggering display of the target frame when the next synchronization signal arrives.

### CROSS REFERENCE TO RELATED APPLICATIONS

This application is a U.S. National Stage entry under 35 U.S.C. § 371 based on International Application No. PCT/CN2019/098833, filed on Aug. 1, 2019, which claims priority to Chinese Patent Application No. 201811646123.7, filed on Dec. 29, 2018. The embodiment of the priority applications are hereby incorporated herein in their entirety by reference.

### TECHNICAL FIELD

The present disclosure relates to the technical field of virtual reality, and in particular, to a method and device for controlling image display in a VR system, and a VR head mounted device.

### BACKGROUND

The VR Head Mounted Device (HMD) continuously tracks the user's head pose in real time via the attitude sensor, and then uses the pose information to render two 2D images (the pictures to be seen by the left eye and the right eye respectively) from the virtual 3D world and display them on the screen. When the user's retina receives the image content, the built-in mechanism of the brain will resolve the stereoscopic effect, thereby realizing the VR (Virtual Reality) effect. Throughout the process, a key index is the system latency, which is the length of time from when the user's head pose is obtained to when the rendered pictures are completely presented on the screen. An excessive system latency may cause the user's physiological senses to be inconsistent with the images received by the eyes, and cause symptoms of motion sickness.

In modern hardware and software systems, the 3D rendering process is a pipelined design. Referring to FIG. 1, starting from the first frame, the input data frames U1 to U4 (for example only) flow through a plurality of threads of the central processor CPU1 and CPU2, GPU (Graphics Processing Unit) and screen, and finally produce an output on the screen after screen scanning. The pipelined design improves the utilization ratio of each component and ensures high throughput, but at the same time, it also brings a high system latency. Referring to FIG. 1, a system latency (Motion to Photon latency) brought by a typical throughput-oriented rendering process, from when the IMU is sampled to obtain the current pose to when the photons emitted due to displaying the first frame on the screen are seen by the user, is at least four screen refresh cycles, and takes 44.4 milliseconds on a screen with a refresh rate of 90 Hz, which far exceeds the physiologically tolerable limit for human body of 18 milliseconds.

To address this problem, there is a Timewarp algorithm that is used to wrap (for example, shift, rotate, adjust, or re-project) image frames so as to correct head motion or translation that occurs after the frame is rendered, thereby reducing the system latency. However, for the sake of simplicity, the conventional Timewarp algorithm only processes images with 3 degrees of freedom (3-DOF) pose, and the image processed by the Timewarp algorithm is not realistic enough and cannot meet the actual needs.

### SUMMARY

The present disclosure provides a method and a device for controlling image display in a VR system and a VR HMD, which expands the applicable scenes of the Timewarp algorithm, so that it can be applied to the control of 6-DOF pose image display, enhance the realism of images and improve the image display effect.

According to an aspect of the present disclosure, a method for controlling image display in a VR system is provided, and the method comprises:

monitoring a synchronization signal of an image frame in a VR system and acquiring an original 2D image;

sampling sensor data at a preset time point before a next synchronization signal arrives to obtain latest pose information of a tracked object, wherein the pose information includes information indicating rotation of the tracked object and information indicating translation of the tracked object;

converting the original 2D image into a corresponding 3D image, and calculating a motion vector corresponding to each pixel point of the 3D image according to the latest pose information and pose information corresponding to the 3D image;

performing position transformation with respect to pixel points of the original 2D image based on the motion vector, and filling at pixel points of a vacant area appearing after the position transformation to obtain a target frame; and

triggering display of the target frame when the next synchronization signal arrives.

According to another aspect of the present disclosure, a device for controlling image display in a VR system is provided, and the device comprises:

an acquisition module, for monitoring a synchronization signal of an image frame in a VR system and acquiring an original 2D image;

a sampling module, for sampling sensor data at a preset time point before a next synchronization signal arrives to obtain latest pose information of an tracked object, wherein the pose information includes information indicating rotation of the tracked object and information indicating translation of the tracked object;

a vector calculation module for converting the original 2D image into a corresponding 3D image, and calculating a motion vector corresponding to each pixel point of the 3D image according to the latest pose information and pose information corresponding to the 3D image;

a target frame generation module, for performing position transformation with respect to pixel points of the original 2D image based on the motion vector, and filling at pixel points of a vacant area appearing after the position transformation to obtain a target frame; and

a triggering module, for triggering display of the target frame when the next synchronization signal arrives.

According to still another aspect of the present disclosure, a VR head mounted device is provided, and the device comprises: a memory and a processor, wherein the memory and the processor are communicatively connected by an internal bus, the memory stores program instructions executable by the processor which enable to implement the method according to an aspect of the present disclosure when executed by the processor.

The method and device for controlling image display in a VR system according to the present disclosure monitors the synchronization signal of the image frame in the VR system and acquires the original 2D image, samples the sensor data at a preset time point before the next synchronization signal arrives to obtain the latest pose information of the tracked object indicating rotation and translation information of the tracked object; calculates the motion vector corresponding to each pixel point of the 3D image, performs position transformation with respect to the pixel points of the original 2D image based on the motion vector, fills at pixel points of a vacant area appearing after the position transformation to obtain a target frame, and triggers display of the target frame when the next synchronization signal arrives. Thus, compared with the prior art, the present disclosure expands the applicable range and scenes of the Timewarp algorithm, and satisfies the requirements of the display control of 6-DOF pose changes; it calculates the new position of the pixel point based on the motion vector corresponding to each pixel point and fills at pixel points of the vacant area to obtain a target frame, thereby improving the realism and display effect of the image. The VR head mounted device according to the present disclosure applies the Timewarp to the scenes with 6-DOF pose changes of the tracked object, shortens the system latency, ensures the realism and display effect of the image, satisfies the actual demand, and enhances the market competitiveness of the product.

### BRIEF DESCRIPTION OF DRAWINGS

FIG. 1 is a schematic diagram of the principle of generation of a system latency;

FIG. 2 is a schematic diagram of the principle of performing image display control using a Timewrap algorithm according to an embodiment of the present disclosure;

FIG. 3a is an image acquired before the position of the tracked object is moved;

FIG. 3b is an enlarged schematic view of the rectangular box of FIG. 3a;

FIG. 4a is an image acquired after the position of the tracked object is moved;

FIG. 4b is an enlarged schematic view of the rectangular box of FIG. 4a;

FIG. 5 is a schematic flow chart of a method for controlling image display in a VR system according to an embodiment of the present disclosure;

FIG. 6 is a schematic diagram of the image shown in FIG. 4a after being added with grids according to an embodiment of the present disclosure;

FIG. 7a is a schematic diagram of the image shown in FIG. 6 after position transformation based on a motion vector;

FIG. 7b is an enlarged schematic view of the part shown by the rectangular box of FIG. 7a;

FIG. 8a is a schematic diagram of the image shown in FIG. 6 after position transformation and filling;

FIG. 8b is an enlarged schematic view of the part shown by the rectangular box of FIG. 8a;

FIG. 9a is a schematic diagram of an original 2D image after being filled using the method of the present disclosure;

FIG. 9b is an enlarged schematic view of the part shown by the rectangular box of FIG. 9a;

FIG. 10 is a block diagram of a device for controlling image display in a VR system according to an embodiment of the present disclosure; and

FIG. 11 is a schematic structural diagram of a VR HMD according to an embodiment of the present disclosure.

### DETAILED DESCRIPTION

In order to make the objects, technical solutions and advantages of the present disclosure clearer, the present disclosure will be further described in detail with reference to the accompanying drawings and specific embodiments. Apparently, the embodiments described are merely some but not all of embodiments of the present disclosure. All other embodiments obtained by those skilled in the art based on the embodiments of the present disclosure without paying any creative efforts shall fall within the protection scope of the present disclosure.

The design concept of the present disclosure lies in that the conventional Timewrap algorithm is improved to expand its applicable range, so that it can be applied to scenes with 6-DOF pose changes to meet actual needs.

In order to facilitate understanding the technical solutions of the embodiments of the present disclosure, the prior art about the Timewrap algorithm and its application to 3-DOF pose change scenes will be described.

To generate a picture on the screen, basically, the following complete process should be performed on the modern rendering engine and GPU:

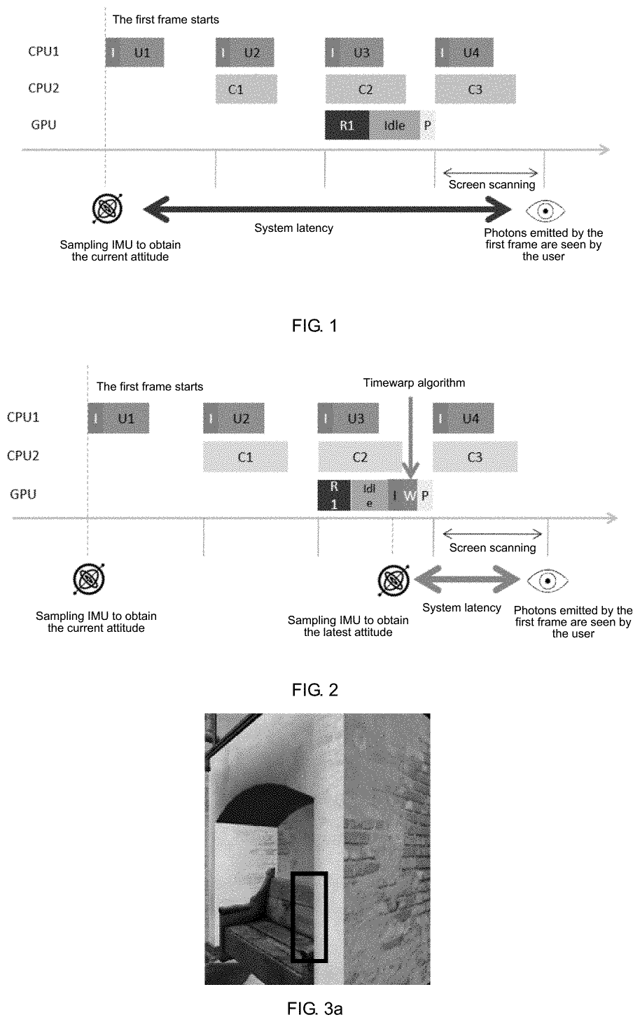

1. Input: collecting all inputs from the user, such as data input via various external devices like a mouse and a keyboard. The IMU (Inertial Measurement Unit) in FIG. 1 is a sensor for collecting attitude data.
2. Update: updating the state of objects in the 3D world according to the user's input, such as updating the camera's position and orientation, updating the movement of the characters in the controlled game application, updating the movement and change of other non-player controlled characters and objects in the game application.
3. Commit: converting all of the updated states of the objects in the 3D world into a series of rendering instructions and submitting them to the GPU for rendering.
4. Render: executing, by the GPU, the series of rendering instructions generated by the previous step (step 3) one by one, and finally generating a 2D image to be seen by the user.

The above is a complete rendering process of a frame of image.

Referring to FIG. 1, I represents the Input phase, U represents the Update phase, C represents the Commit phase, and R represents the Render phase. As shown in FIG. 1, the four frames processed in CPU1 (namely, U1, U2 to U4) are in the update phase, the three frames processed in CPU2 (namely, C1, C2 to C3) are in the commit phase, and the one frame processed in the GPU is in the rendering phase.

According to the screen refresh mechanism, when the 2D image is pushed to the screen, it is necessary to wait for the next synchronization signal to arrive, and it cannot be pushed until the next synchronization signal arrives. Therefore, after the GPU renders the instructions of the current frame, there is no task to be processed, and it will enter an idle state (see Idle after R1 in FIG. 1).

If explained in conjunction with Timewarp, it mainly comprises the following parts (see FIG. 1):

Step 1: after the update thread samples the pose, it updates the world state and then submits the pipeline. This phase takes 1 screen refresh cycle. For example, if the refresh frequency of the screen is 60 Hz, a refresh cycle is 1000/60≈33.3 ms; if the refresh frequency of the screen is 90 Hz, and a refresh cycle is 1000/90≈11.1 ms.

Step 2: the time that the render thread submits the rendering instructions to the GPU based on the latest 3D world state and pose. This phase takes 1 screen refresh cycle.

Step 3: the time that the 3D image is rasterized (i.e., rendered) to generate a 2D image and waits for the screen synchronization signal. The time consumed by the rasterization depends on the complexity of the scene in the current pose. It usually requires the content designer to ensure that the time is less than 1 screen refresh period to ensure a stable frame rate. This step takes at least 1 screen refresh period. If the rasterization takes up n.m refresh cycles, the overall time consumed by this step is rounded up to (n+1) screen refresh cycles.

Step 4: the time of transmitting 2D image data to the screen and scanning the screen plus the time of actually emitting photons takes a total of 1 refresh cycle.

Therefore, a system latency brought by a typical throughput-oriented rendering process is at least four screen refresh cycles, and takes 44.4 milliseconds on a screen with a refresh rate of 90 Hz, which far exceeds the physiologically tolerable limit for human body of 18 ms.

With respect to this problem, the Timewarp algorithm inserts some additional steps after rasterizing the image and before waiting for the next screen synchronization signal in Step 3 above to reduce the system latency. In other words, Steps 3 is changed into the following sub-steps. Referring to FIG. 2, it mainly includes the following operations:

1) rasterizing to generate a 2D image and caching it as an original image;
2) waiting for a certain period of time until the next synchronization signal will immediately arrive;
3) performing a new sampling of the pose to obtain the pose of the user's head at the current moment;
4) using the latest pose to transform the cached original image to generate an image that should be seen under the new attitude (i.e., the target image); and
5) refreshing the target image to the screen to display when the immediately following synchronization signal arrives.

Timewarp is established because the complexity of transforming a 2D image depends only on the image resolution and it is much shorter than the rasterization time of the 3D scene. Usually this process takes 2 to 3 ms, so before the image is refreshed to the screen, as long as 4 ms is reserved to transform the image with the latest pose, the effect of reducing the overall system latency can be achieved.

As shown in FIG. 2, after applying the Timewarp algorithm, the system latency is reduced from 4 refresh cycles to Timewarp time+1 refresh cycle. For a screen with a refresh rate of 90 Hz, the total time is 11.1+4=15.1 (ms) which is less than 18 ms and can meet the demand.

It should be noted that U1, U2, C1, C2, etc. illustrated in FIG. 2 have the same meanings as the symbols in FIG. 1, so they may refer to the foregoing related description of FIG. 1 and will not be repeated herein. Only the difference between FIG. 2 and FIG. 1 will be briefly explained herein. In FIG. 2, I after the “Idle” (idle state) indicates that the user's input “Input” is taken again (i.e., the IMU is sampled to get the latest attitude, as shown in FIG. 2), and the following W indicates the execution of the actual Timewarp process (i.e., the process of time wrap and frame filling described in the present disclosure, see the Timewrap shown in FIG. 2 connected by the arrow), and the further following P indicates Present, namely, when the next synchronization signal arrives, the transformed target 2D image is actually pushed to (displayed on) the screen.

Regarding the degree of freedom, any unrestrained object has six independent motions in space, namely, 6-DOF (Degrees of Freedom). Taking a VR device as an example, a VR device can have three translational motions and three rotational motions in a rectangular coordinate system oxyz, namely, translational motions along the x, y, and z axes and rotational motions around the x, y, and z axes, respectively. It is customary to refer to the above six independent movements as six degrees of freedom.

The Timewarp algorithm based on 3 degrees of freedom (i.e., 3-DOF) only considers rotation of direction and does not consider positional translation when it is implemented, because the scene occlusion relationship in a 2D image does not change when only the rotation of direction is processed, and thus the Timewarp algorithm is easier to implement but has the problem of insufficient realism. If the Timewarp algorithm is applied to a 6-DOF scene, it will be much more complicated, because it must consider both the rotation and the change of the occlusion relationships among objects caused by displacement.

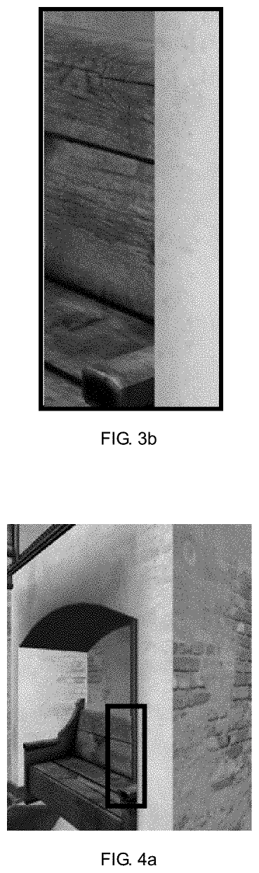

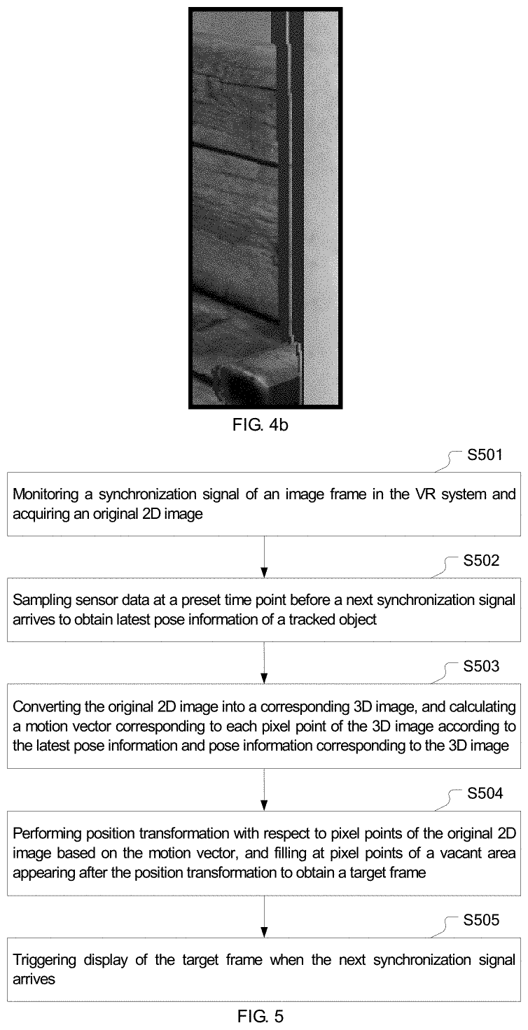

The change of the image in the above 6-DOF pose scene will be described with reference to FIG. 3a to FIG. 4b. FIG. 3a is an image acquired before the position of the tracked object is moved, herein the tracked object is, for example, the head of the wearer of the VR HMD. FIG. 3a illustrates the picture taken by a camera on the VR HMD before the head position is moved; FIG. 3b illustrates the enlarged image of the black rectangular box in FIG. 3a, and it can be seen that the wall blocks a corner of the bench.

Turning to FIG. 4a, after the wearer's head moves to the left, the camera on the VR HMD moves to the left, and the black rectangular box in the picture taken by the camera exposes the blocked area before the movement. Referring to FIG. 4b, after the black rectangular box in FIG. 4a is enlarged, it can be seen that there are two strip-shaped black areas in the range enclosed by the rectangular box, which are the areas not originally displayed but exposed after the user's head translated to the left. Due to the displacement, the scene occlusion relationship changes, and some contents that are blocked in the original image (the image before the movement) will be exposed in the field of view in the target image (the image after the movement), but these contents have no corresponding information saved in the original image, and must be reconstructed by certain algorithms and methods.

Timewrap algorithms in the prior art do not consider the image processing in the case of 6-DOF pose changes, so they do not give any corresponding solution. The present disclosure is directed to the above technical problem, and extends the application of the Timewrap algorithm in the case of 6-DOF pose changes to fill the gap, and at the same time, improves the realism of the reconstructed image and ensures the image display effect.

FIG. 5 shows a method for controlling image display in a VR system according to an embodiment of the present disclosure. Referring to FIG. 5, the method comprises the following steps:

Step S501, monitoring a synchronization signal of an image frame in the VR system and acquiring an original 2D image;

Step S502, sampling sensor data at a preset time point before a next synchronization signal arrives to obtain latest pose information of a tracked object, wherein the pose information includes information indicating rotation of the tracked object and information indicating translation of the tracked object;

Step S503, converting the original 2D image into a corresponding 3D image, and calculating a motion vector corresponding to each pixel point of the 3D image according to the latest pose information and pose information corresponding to the 3D image;

Step S504, performing position transformation with respect to pixel points of the original 2D image based on the motion vector, and filling at pixel points of a vacant area appearing after the position transformation to obtain a target frame; and

Step S505, triggering display of the target frame when the next synchronization signal arrives.

As shown in FIG. 1, in the present embodiment, after obtaining the original 2D image, there is a waiting time. In other words, there is a preset time point before the arrival of the next synchronization signal. At this preset time point, the latest pose information of the head including direction rotation information and position translation information is acquired. The motion vector corresponding to each pixel point of the 3D image is calculated based on the latest pose information and the image transformed into the 3D space. The position of the pixel point in the 2D image is adjusted based on the vector, and the vacant area (see the black strip area in FIG. 4b) appearing after the position transformation is filled with supplemental information to obtain a target frame. The target frame is displayed when the next synchronization signal arrives. Thus, on the one hand, the time from sampling and obtaining the latest pose to generating and displaying the target frame according to the pose is greatly shortened, namely, the system latency is significantly reduced. On the other hand, the Timewrap algorithm can be used to recover and reconstruct the target frame in the 6-DOF pose change scene, which improves the realism of the image, ensures the display effect, broadens the application range of the VR system, and enhances the market competitiveness of the product.

The implementation steps of the present embodiment are described below in conjunction with a specific application scenario.

It can be understood that, when the method for controlling image display in a VR system according to the present embodiment is applied to a VR HMD, the wearer of the HMD can both move and rotate, thereby reducing restraints on the movement of the wearer and increasing user satisfaction. At the same time, the method according to the present embodiment fills the absent image information caused by the head position translation to generate a target frame and display the target frame, which ensures the realism of image and the image display effect. It should be noted that the tracked object is not limited to the head, and may also be the hand.

Generally speaking, the method for controlling image display in a VR system according to the present embodiment is to cache the depth information (Z-buffer) corresponding to each pixel while rasterizing to generate the original 2D image, and then use the depth information to transform each pixel back to the 3D space, and calculate the corresponding motion vector in the 3D space; finally, divide the original 2D image into dense grids, and transform each pixel in the original 2D image using the motion vector, and fill the vacant area using pixel interpolation between the grids to obtain a target frame.

Specifically, in the method for controlling image display in a VR system according to the present embodiment, the synchronization signal of the image frame in the VR system is monitored, and at a preset time point before the next synchronization signal arrives, for example, at the time point 5 ms before the next synchronization signal arrives (the specific time point depends on the execution time of the Timewarp algorithm, and further depends on the resolution of the original image and the computing power of the GPU hardware, and can be determined according to the actual test.), the Timewarp is executed once, and the flow is as follows:

First, an original 2D image is acquired.

Herein, the original 2D image is acquired by rasterizing the 3D image captured by the depth camera in the world space to generate a 2D original image, and Z-buffer depth information is generated simultaneously with rasterization. In the present embodiment, the depth information of the original image is saved and the 6-DOF pose (O, P) used at the moment is recorded.

It should be noted that, the Z-buffer saves the depth information of each pixel point in the original image to restore the 3D coordinates of the pixel. In the 6-DOF pose (O, P), O indicates the rotation of the user's head, i.e., direction information (u, v, w), and P indicates the translation of the position of the user's head, i.e., position information (x, y, z). The latest pose information of the user's head can be obtained by sampling the inertial measurement unit (IMU) data of the VR system.

Second, a motion vector is calculated.

Herein, the motion vector is calculated by inversely transforming the 2D pixel back into the 3D space to obtain a corresponding motion vector.

For example, a corresponding original position of each pixel point of the 3D image in a 3D space corresponding to the original 2D image is calculated by using the inverse matrix of the matrix used in 3D to 2D spatial transformation; a corresponding new position of each pixel point in the 3D space is calculated according to an offset between the latest pose information and the pose information corresponding to the 3D image; and the motion vector corresponding to each pixel point of the 3D image is calculated and obtained by using the original position and the new position of each pixel point in the 3D space.

Specifically, an inverse matrix M is generated for the spatial transformation matrix used in rasterization. The horizontal position information, vertical position information, and depth information of each pixel point of the original 2D image are acquired, and a position vector of each pixel point of the original 2D image is obtained. A corresponding original position of each pixel point of the 3D image in a 3D space corresponding to the original 2D image is calculated using the inverse matrix of the matrix used in 3D to 2D spatial transformation and the position vector of each pixel point.

In other words, the horizontal position information and the vertical position information, i.e., the coordinates (x, y), of the pixel point are read from the original image, and the depth of the pixel, i.e., the z coordinate, is read from the Z-buffer, and the position vector, i.e., the coordinates (x, y, z), in the 2D space (i.e., the image space) of each pixel point is obtained.

Inverse transformation is performed on the position vector (x, y, z) using the inverse matrix M, namely, matrix and vector multiplication (x′, y′, z′)=M×(x, y, z) is performed, to obtain the coordinates of the pixel points in the original 3D space.

It should be noted that the pixel points in the 2D image and the pixel points in the 3D image actually describe the same objects, except that the description manners in different spaces and the reflected physical characteristics are different.

Next, the new position (x″, y″, z″) of each pixel point (x′, y′, z′) in the 2D image is calculated using the change between the corresponding pose information (O, P) of the 2D image and the latest pose information (O′, P′) obtained by sampling.

Finally, a motion vector (n, m, k) is obtained from the original position (x′, y′, z′) and the new position (x″, y″, z″) of each pixel point.

Third, the motion vector is applied to the original 2D image.

In the present embodiment, applying the motion vector to the original 2D image is that, position transformation is performed with respect to the pixel point of the original 2D image based on the motion vector, and a color is filled at pixel points of a vacant area appearing after the position transformation to obtain a target frame.

In order to achieve the optimum image effect, position transformation may be performed with respect to every pixel point of the original 2D image based on the motion vector of every pixel point, and a color is filled at the pixel points of the vacant area appearing after the position transformation to obtain the target frame. However, the disadvantages of doing so are also obvious, namely, the calculation intensity is large and the efficiency is low. In addition, system resources are wasted when the image resolution is low. Therefore, in practical applications, some pixel points may be selected for position transformation after weighing the image resolution, calculation intensity, and image effect.

In an embodiment of the present disclosure, a part of the pixel points are selected from the pixel points of the original 2D image as key pixel points; and position transformation is performed with respect to each selected key pixel point based on the size and direction indicated by the motion vector.

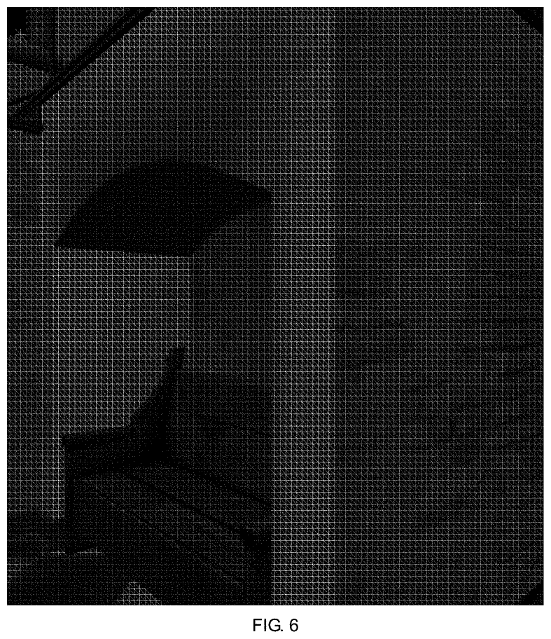

Herein, selecting a part of key pixel points from the pixel points of the original 2D image comprises: dividing the original 2D image into a plurality of regular grids, and selecting pixel points corresponding to grid vertices as key pixel points. Referring to FIG. 6, regular grids, for example, 200×100 grids, are created for the original image, and the pixel points corresponding to the grid vertices are selected as the key pixel points. The denser the grids are, the larger the amount of calculation is, and the better the quality of the corresponding generated image is.

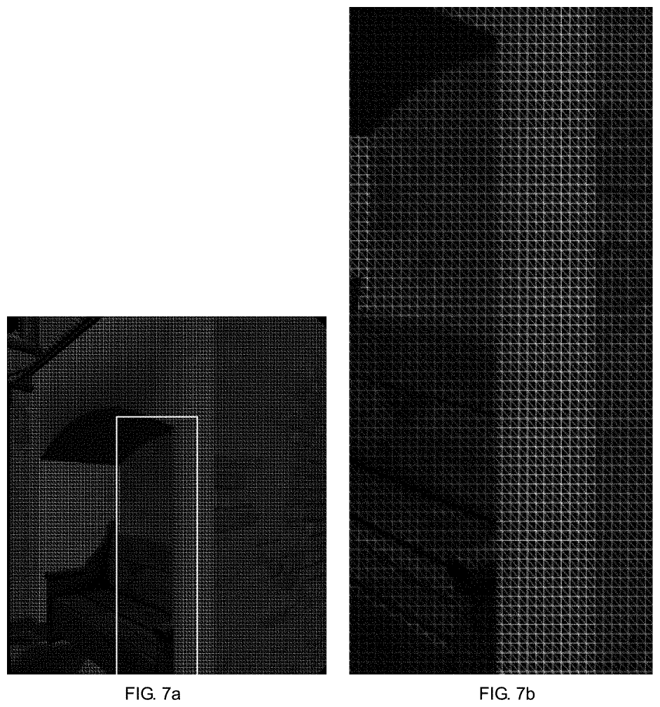

After dividing into grids, position transformation is performed with respect to the selected pixel points corresponding to the grid vertices based on the size and direction indicated by the motion vector. FIG. 7a is a schematic diagram showing the image shown in FIG. 6 after position transformation based on the motion vector; FIG. 7b is an enlarged schematic view of the portion shown in the rectangular box of FIG. 7a. As shown in FIG. 7a and FIG. 7b, after performing position transformation with respect to pixel points corresponding to the grid vertices shown in FIG. 6, a vacant area appears since a part of the pixel points in the area surrounded by the grid vertices has no color information.

Finally, it is filled where the pixel points of the vacant area are.

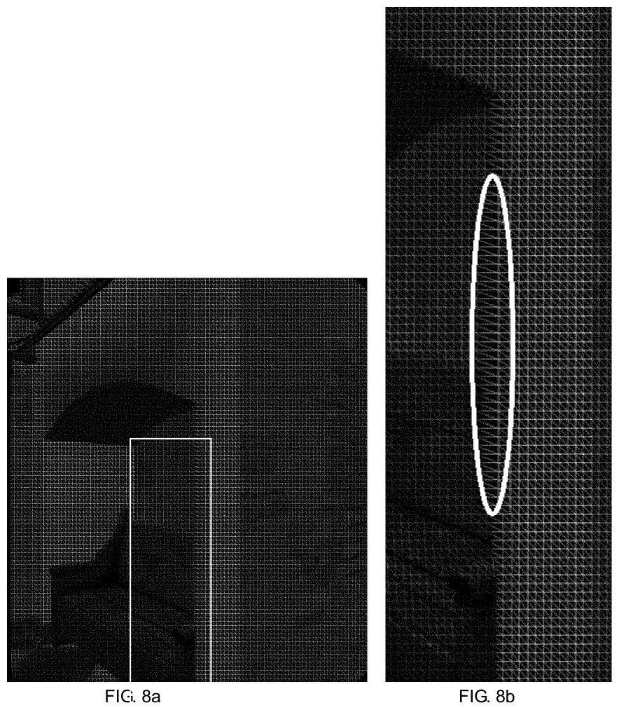

In the present embodiment, the pixel points of the vacant area appearing after the position transformation are filled to obtain the target frame. Specifically, a vacant area in the area enclosed by grid vertices after the position transformation is determined, and the pixel points of the vacant area are filled by interpolation. For example, the pixel position between the vertices is calculated by the linear interpolation built in the GPU to achieve the reconstruction effect. FIG. 8a is a schematic diagram of the image shown in FIG. 6 after position transformation and filling; FIG. 8b is the enlarged schematic view of the part shown by the rectangular box in FIG. 8a. As shown in FIG. 8a and FIG. 8b, while the grid completes the position transformation, the pixels in the middle vacant area will be automatically filled by the GPU. Since it is a grid map, FIG. 8b fails to exhibit the color effect easily recognized by the human eye, but it can be clearly seen that the grids after filled create a stretching effect, as shown in the white circle in FIG. 8b.

It should be noted that, during actual use, there is no strict sequence between the step of applying the motion vector to the original 2D image and the step of filling the pixel points of the vacant area, and they may be completed simultaneously using the GPU's built-in mechanism.

After this timewarp transformation ends, the final target image is obtained. The content of the target image reflects the image seen by the user in the latest head pose. Subsequently the target image will be refreshed to the screen for display.

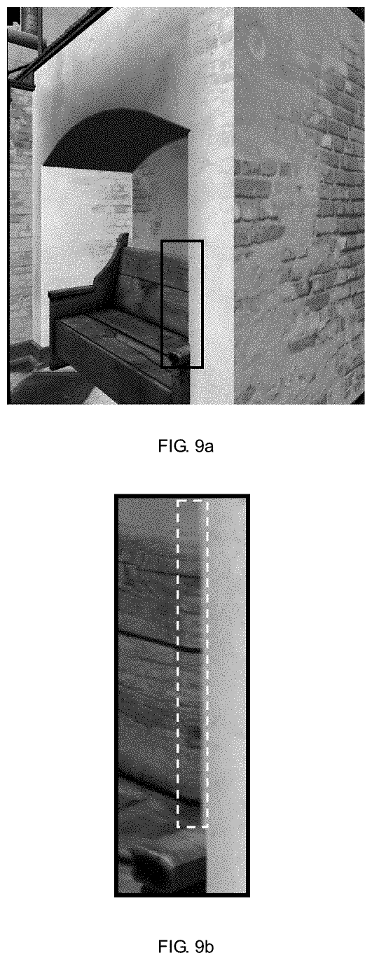

FIG. 9a is a schematic diagram of the original 2D image after filled using the method according to the present embodiment, and FIG. 9b is an enlarged schematic view of the rectangular box of FIG. 9a. Comparing FIG. 9b with FIG. 4b, it can be seen that the content filled by the method is more realistic and feasible. The blocked area is the wood texture of a wooden chair, the method uses the wooden chair texture (see the white dotted rectangular box in FIG. 9b) to fill, and the edges of the walls and wooden chairs remain in a vertical shape, making the image more realistic. Compared with the prior art in which the vacant area is mistakenly filled with the texture of the wall such that the edge of the wall as a whole bends leftward and the filling effect is not true, the present embodiment improves the realism of image.

Therefore, the method for controlling image display in a VR system according to the present disclosure expands the application scenes of the Timewarp, the method is simple and easy to operate, the calculation intensity is lower, no additional hardware resources are needed, the operation efficiency is high, the realism of image is guaranteed, and the user experience is improved.

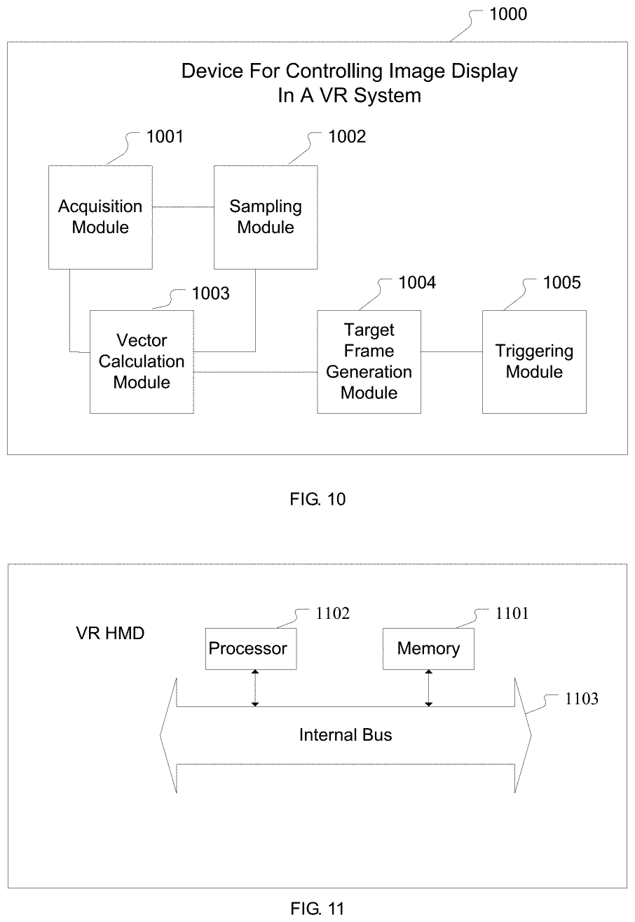

The present disclosure further provides a device for controlling image display in a VR system, which belongs to the same technical concept as the foregoing method for controlling image display in a VR system. FIG. 10 is a block diagram of the device for controlling image display in a VR system according to an embodiment of the present disclosure. The device 1000 for controlling image display in a VR system comprises:

an acquisition module 1001, for monitoring a synchronization signal of an image frame in a VR system and acquiring an original 2D image;

a sampling module 1002, for sampling sensor data at a preset time point before a next synchronization signal arrives to obtain latest pose information of an tracked object, wherein the pose information includes information indicating rotation of the tracked object and information indicating translation of the tracked object;

a vector calculation module 1003, for converting the original 2D image into a corresponding 3D image, and calculating a motion vector corresponding to each pixel point of the 3D image according to the latest pose information and pose information corresponding to the 3D image;

a target frame generation module 1004, for performing position transformation with respect to pixel points of the original 2D image based on the motion vector, and filling at pixel points of a vacant area appearing after the position transformation to obtain a target frame; and

a triggering module 1005, for triggering display of the target frame when the next synchronization signal arrives.

In an embodiment of the present disclosure, the target frame generating module 1004 is specifically for dividing the original 2D image into a plurality of regular grids (for example, dividing the original 2D image into 200×100 regular grids), and selecting pixel points corresponding to grid vertices as key pixel points; and performing position transformation with respect to each selected key pixel point based on a size and a direction indicated by the motion vector, and filling at pixel points of a vacant area appearing after the position transformation to obtain a target frame.

In an embodiment of the present disclosure, the vector calculation module 1003 is specifically for calculating a corresponding original position of each pixel point of the 3D image in a 3D space corresponding to the original 2D image by using an inverse matrix of a matrix used in 3D to 2D spatial transformation; calculating a corresponding new position of each pixel point in the 3D space according to an offset between the latest pose information and the pose information corresponding to the 3D image; and calculating to obtain the motion vector corresponding to each pixel point of the 3D image by using the original position and the new position of each pixel point in the 3D space.

In an embodiment of the present disclosure, the vector calculation module 1003 is for acquiring horizontal position information, vertical position information, and depth information of each pixel point of the original 2D image, and obtaining a position vector of each pixel point of the original 2D image; and calculating a corresponding original position of each pixel point of the 3D image in a 3D space corresponding to the original 2D image, by using an inverse matrix of a matrix used in 3D to 2D spatial transformation and the position vector of each pixel point.

In an embodiment of the present disclosure, the target frame generating module 1004 is for selecting a part of the pixel points from the pixel points of the original 2D image as key pixel points; and performing position transformation with respect to each selected key pixel point based on a size and a direction indicated by the motion vector, and filling at pixel points of a vacant area appearing after the position transformation to obtain a target frame.

In an embodiment of the present disclosure, the target frame generating module 1004 is for determining a vacant area in an area enclosed by grid vertices after the position transformation; and filling pixel points of the vacant area by interpolation.

In an embodiment of the present disclosure, the sampling module 1002 samples the inertial measurement unit (IMU) data of the VR system to obtain the latest pose information of the user's head.

It should be noted that the device for controlling image display in a VR system shown in FIG. 10 corresponds to the foregoing method for controlling image display in a VR system, and thus the exemplary illustration of the functions realized by the device for controlling image display in a VR system in the present embodiment may refer to the related description of the foregoing embodiments of the present disclosure, and will not be repeated herein.

FIG. 11 is a schematic structural diagram of a VR HMD according to an embodiment of the present disclosure. As shown in FIG. 11, the VR HMD comprises a memory 1101 and a processor 1102. The memory 1101 and the processor 1102 are communicatively connected by an internal bus 1103. The memory 1101 stores program instructions executable by the processor 1102. When the program instructions are executed by the processor 1102, the foregoing method for controlling image display in a VR system can be implemented.

In addition, the logic instructions in the memory 1101 described above may be stored in a computer-readable storage medium when being implemented in the form of a software functional module and sold and used as an independent product. Based on such an understanding, the substance or the part that contributes to the prior art of the technical solutions of the present disclosure, or a part of the technical solution, may be embodied in the form of a software product. The computer software product may be stored in a storage medium, and include several instructions for causing a computer device (which may be a personal computer, a server, or a network device) to fully or partially perform the method described in the various embodiments of the present disclosure. The storage medium includes various mediums capable of storing program codes, such as a U disk, a mobile hard disk, a read-only memory (ROM), a random access memory (RAM), a magnetic disk, or an optical disk.

Another embodiment of the present disclosure provides a computer readable storage medium storing computer instructions that cause the computer to perform the method described above.

As will be appreciated by a person skilled in the art, the embodiments of the present disclosure may be embodied as a system, method or computer program product. Thus, the present disclosure may take the form of an entirely hardware embodiment, an entirely software embodiment, or an embodiment combining software and hardware. Furthermore, the present disclosure may take the form of a computer program product embodied on one or more computer-usable storage media (including but not limited to magnetic storage media, CD-ROMs and optical storage media) having computer-usable program codes recorded thereon.

The present disclosure is described with reference to flowchart illustrations and/or block diagrams of methods, apparatus (systems) and computer program products according to embodiments of the present disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, embedded processing apparatus, or other programmable data processing apparatus to produce a machine, such that the instructions, which execute via the processor of the computer or other programmable data processing apparatus, create means for implementing the functions specified in the flowchart and/or block diagram block or blocks.

It should be noted that the terms “comprise”, “include” or any other variants are intended to cover non-exclusive inclusion, so that the process, method, article or apparatus including a series of elements may not only include those elements, but may also include other elements not stated explicitly, or elements inherent to the process, method, articles or apparatus. Without more limitations, an element defined by the sentence “comprising a . . . ” does not exclude the case that there are other same elements in the process, method, article or apparatus including the element.

The above merely describes particular embodiments of the present disclosure. By the teaching of the present disclosure, a person skilled in the art can make other modifications or variations based on the above embodiments. A person skilled in the art should appreciate that, the detailed description above is only for the purpose of better explaining the present disclosure, and the protection scope of the present disclosure should be subject to the protection scope of the claims.

What is claimed is:

1. A method for controlling image display in a VR system, comprising:
monitoring a synchronization signal of an image frame in the VR system and acquiring an original 2D image;
sampling sensor data at a preset time point before a next synchronization signal arrives to obtain latest pose information of a tracked object, wherein the pose information includes information indicating rotation of the tracked object and information indicating translation of the tracked object;
converting the original 2D image into a corresponding 3D image, and calculating a motion vector corresponding to each pixel point of the 3D image according to the latest pose information and pose information corresponding to the 3D image;
performing position transformation with respect to pixel points of the original 2D image based on the motion vector, and filling at pixel points of a vacant area appearing after the position transformation to obtain a target frame; and
triggering display of the target frame when the next synchronization signal arrives.

2. The method according to claim 1, wherein calculating a motion vector corresponding to each pixel point of the 3D image according to the latest pose information and pose information corresponding to the 3D image comprises:
calculating a corresponding original position of each pixel point of the 3D image in a 3D space corresponding to the original 2D image, by using an inverse matrix of a matrix used in 3D to 2D spatial transformation;
calculating a corresponding new position of each pixel point in the 3D space according to an offset between the latest pose information and the pose information corresponding to the 3D image; and
calculating to obtain the motion vector corresponding to each pixel point of the 3D image by using the original position and the new position of each pixel point in the 3D space.

3. The method according to claim 2, wherein calculating a corresponding original position of each pixel point of the 3D image corresponding to the original 2D image in a 3D space by using an inverse matrix of a matrix used in 3D to 2D spatial transformation comprises:
acquiring horizontal position information, vertical position information, and depth information of each pixel point of the original 2D image, and obtaining a position vector of each pixel point of the original 2D image; and
calculating a corresponding original position of each pixel point of the 3D image in a 3D space corresponding to the original 2D image, by using an inverse matrix of a matrix used in 3D to 2D spatial transformation and the position vector of each pixel point.

4. The method according to claim 1, wherein performing position transformation with respect to pixel points of the original 2D image based on the motion vector, and filling at pixel points of a vacant area appearing after the position transformation to obtain a target frame comprises:
selecting a part of the pixel points from the pixel points of the original 2D image as key pixel points; and
performing position transformation with respect to each selected key pixel point based on a size and a direction indicated by the motion vector, and filling at pixel points of a vacant area appearing after the position transformation to obtain a target frame.

5. The method according to claim 4, wherein selecting a part of the pixel points from the pixel points of the original 2D image as key pixel points comprises:
dividing the original 2D image into a plurality of regular grids, and selecting pixel points corresponding to grid vertices as key pixel points.

6. The method according to claim 5, wherein filling at pixel points of a vacant area appearing after the position transformation comprises:
determining a vacant area in an area enclosed by grid vertices after the position transformation; and
filling pixel points of the vacant area by interpolation.

7. The method according to claim 1, wherein sampling sensor data to obtain latest pose information of a tracked object comprises:
sampling data of an inertial measurement unit (IMU) of a VR system to obtain latest pose information of a user's head.

8. The method according to claim 1, wherein the original 2D image is divided into 200×100 regular grids.

9. A device for controlling image display in a VR system, comprising:
an acquisition module, for monitoring a synchronization signal of an image frame in a VR system and acquiring an original 2D image;
a sampling module, for sampling sensor data at a preset time point before a next synchronization signal arrives to obtain latest pose information of an tracked object, wherein the pose information includes information indicating rotation of the tracked object and information indicating translation of the tracked object;
a vector calculation module for converting the original 2D image into a corresponding 3D image, and calculating a motion vector corresponding to each pixel point of the 3D image according to the latest pose information and pose information corresponding to the 3D image;
a target frame generation module, for performing position transformation with respect to pixel points of the original 2D image based on the motion vector, and filling at pixel points of a vacant area appearing after the position transformation to obtain a target frame; and
a triggering module, for triggering display of the target frame when the next synchronization signal arrives.

10. The device according to claim 9, wherein the vector calculation module is specifically for
calculating a corresponding original position of each pixel point of the 3D image in a 3D space corresponding to the original 2D image, by using an inverse matrix of a matrix used in 3D to 2D spatial transformation;
calculating a corresponding new position of each pixel point in the 3D space according to an offset between the latest pose information and the pose information corresponding to the 3D image; and
calculating to obtain the motion vector corresponding to each pixel point of the 3D image by using the original position and the new position of each pixel point in the 3D space.

11. The device according to claim 10, wherein the vector calculation module is specifically for
acquiring horizontal position information, vertical position information, and depth information of each pixel point of the original 2D image, and obtaining a position vector of each pixel point of the original 2D image; and
calculating a corresponding original position of each pixel point of the 3D image corresponding to the original 2D image in a 3D space, by using an inverse matrix of a matrix used in 3D to 2D spatial transformation and the position vector of each pixel point.

12. The device according to claim 9, wherein the target frame generating module is specifically for
selecting a part of the pixel points from the pixel points of the original 2D image as key pixel points; and
performing position transformation with respect to each selected key pixel point based on a size and a direction indicated by the motion vector, and filling at pixel points of a vacant area appearing after the position transformation to obtain a target frame.

13. The device according to claim 9, wherein the target frame generating module is specifically for dividing the original 2D image into a plurality of regular grids, and selecting pixel points corresponding to grid vertices as key pixel points.

14. The device according to claim 13, wherein the target frame generating module is specifically for determining a vacant area in an area enclosed by grid vertices after the position transformation; and filling pixel points of the vacant area by interpolation.

15. The device according to claim 13, wherein the target frame generating module is specifically dividing the original 2D image into 200×100 regular grids.

16. A VR head mounted device, comprising: a memory and a processor, wherein the memory and the processor are communicatively connected by an internal bus, the memory stores program instructions executable by the processor which enable to implement the method according to claim 1 when executed by the processor.

17. The VR head mounted device according to claim 16, wherein calculating a motion vector corresponding to each pixel point of the 3D image according to the latest pose information and pose information corresponding to the 3D image comprises:
calculating a corresponding original position of each pixel point of the 3D image in a 3D space corresponding to the original 2D image, by using an inverse matrix of a matrix used in 3D to 2D spatial transformation;
calculating a corresponding new position of each pixel point in the 3D space according to an offset between the latest pose information and the pose information corresponding to the 3D image; and
calculating to obtain the motion vector corresponding to each pixel point of the 3D image by using the original position and the new position of each pixel point in the 3D space.

18. The VR head mounted device according to claim 17, wherein calculating a corresponding original position of each pixel point of the 3D image corresponding to the original 2D image in a 3D space by using an inverse matrix of a matrix used in 3D to 2D spatial transformation comprises:
acquiring horizontal position information, vertical position information, and depth information of each pixel point of the original 2D image, and obtaining a position vector of each pixel point of the original 2D image; and
calculating a corresponding original position of each pixel point of the 3D image in a 3D space corresponding to the original 2D image, by using an inverse matrix of a matrix used in 3D to 2D spatial transformation and the position vector of each pixel point.

19. The VR head mounted device according to claim 16, wherein performing position transformation with respect to pixel points of the original 2D image based on the motion vector, and filling at pixel points of a vacant area appearing after the position transformation to obtain a target frame comprises:
selecting a part of the pixel points from the pixel points of the original 2D image as key pixel points; and
performing position transformation with respect to each selected key pixel point based on a size and a direction indicated by the motion vector, and filling at pixel points of a vacant area appearing after the position transformation to obtain a target frame.

20. The VR head mounted device according to claim 19, wherein selecting a part of the pixel points from the pixel points of the original 2D image as key pixel points comprises:
dividing the original 2D image into a plurality of regular grids, and selecting pixel points corresponding to grid vertices as key pixel points;
and wherein filling at pixel points of a vacant area appearing after the position transformation comprises:
determining a vacant area in an area enclosed by grid vertices after the position transformation; and
filling pixel points of the vacant area by interpolation.
